(19) United States
(12) Patent Application Publication
(10) Pub. No.: US 2012/0008349 A1
(43) Pub. Date: Jan. 12, 2012

(54) POWER INVERTER SYSTEMS WITH HIGH-ACCURACY REFERENCE SIGNAL GENERATION AND ASSOCIATED METHODS OF CONTROL

(76) Inventor: Mesa P. Scharf, Redmond, OR (US)

(21) Appl. No.: 13/181,269

(22) Filed: Jul. 12, 2011

Related U.S. Application Data
(60) Provisional application No. 61/363,644, filed on Jul. 12, 2010.

(51) Int. Cl. H02M 1/00

(52) U.S. Cl. 363/40

(57) ABSTRACT

Power converter systems with high accuracy signal generation and associated methods are disclosed herein. In one embodiment, a method for controlling an inverter coupled to a grid includes receiving data representing a voltage signal of the grid, analyzing the received data in frequency domain, and extracting a fundamental frequency component from the analyzed data in frequency domain. The method can also include calculating a waveform based on the fundamental frequency component and controlling an output of the inverter based on the calculated waveform.

### CROSS-REFERENCE TO RELATED APPLICATION(S)

This application claims the benefit of U.S. Provisional Patent Application No. 61/363,644 filed Jul. 12, 2010 (entitled POWER INVERTER SYSTEMS WITH HIGH-ACCURACY REFERENCE SIGNAL GENERATION AND ASSOCIATED METHODS OF CONTROL), which is related to U.S. Provisional Patent Application No. 61/355,119 filed Jun. 15, 2010 (entitled GRID INTEGRATION OF PHOTOVOLTAIC INVERTERS WITH A NOVEL ISLAND DETECTION TECHNIQUE), each of which is incorporated herein by reference in its entirety.

### TECHNICAL FIELD

This application is generally directed to power inverter systems with high-accuracy reference signal generation and associated methods of control.

### BACKGROUND

Distributed electrical generation systems can include a plurality of photovoltaic (PV) arrays, micro hydroelectric turbines, and/or other energy sources linked to a grid. To feed power to the grid, the energy sources typically utilize a grid-tie inverter (“GTI”) that can convert direct current (“DC”) from the energy sources into alternating current (“AC”) and feed the AC power to the grid. For stable operation of the grid, GTIs must synchronize respective output frequencies with that of a grid (e.g., 60 Hz). One conventional synchronization technique includes monitoring and identifying frequency waveforms, zero crossings, and/or other suitable line references of a grid voltage and adjusting power output of the GTIs to inject AC power based on the identified line references.

One operational difficulty of the foregoing synchronization technique is that the identified frequency waveforms, zero crossings, and/or other line references may not be reliable and/or stable. For example, if the grid voltage has high total harmonic distortion (“THD”), double zero crossings, and/or other types of distortions, a reliable line reference of the grid voltage may not be readily established. The lack of a reliable line reference can degrade control stability of the grid, causing echoing of grid THD, and/or can result in other problems for the grid. Accordingly, several improvements in reliably and efficiently identifying a line reference of a grid are needed.

### BRIEF DESCRIPTION OF THE DRAWINGS

FIG. 1 is a diagram illustrating a power system configured in accordance with embodiments of the technology.

FIG. 2 is a block diagram illustrating components of a solar power inverter configured in accordance with an embodiment of the technology.

FIG. 3 is a flow diagram of a method for deriving a high-accuracy line reference signal of a grid in accordance with an embodiment of the technology.

FIG. 4A is a voltage versus time plot of an example of a measured voltage signal and a corresponding derived line reference in accordance with an embodiment of the technology.

FIG. 4B is a voltage versus frequency plot of the example of measured grid voltage signal of FIG. 4A in frequency domain.

### DETAILED DESCRIPTION

Various embodiments of power systems, inverters, and methods for generating high-accuracy reference signals are described blow. Certain details are set forth in the following description and corresponding Figures to provide a thorough understanding of various embodiments of the technology. Many of the details, dimensions, angles and other features shown in the Figures are merely illustrative of particular embodiments. Accordingly, other embodiments can have other details, dimensions, angles, and features. In addition, further embodiments can be practiced without several of the details described below.

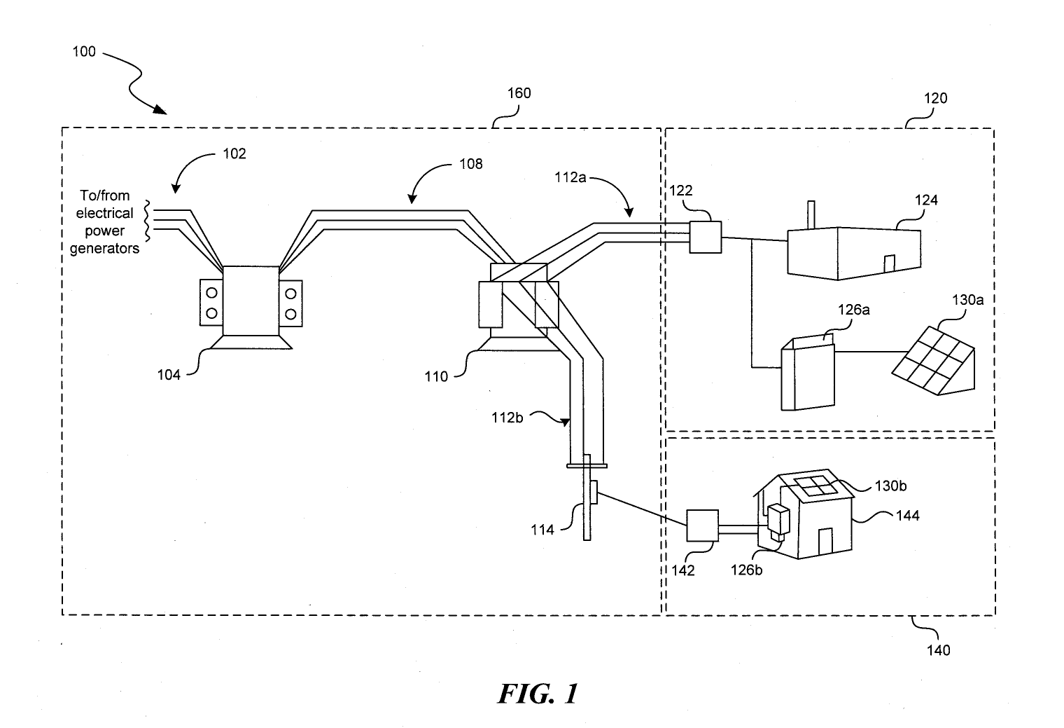

FIG. 1 is a schematic diagram illustrating a power system 100 configured in accordance with embodiments of the technology. As shown in FIG. 1, in the illustrated embodiment, the power system 100 includes a utility grid 160 electrically coupled to customer premises 120 and 140. In other embodiments, the power system 100 can also include other loads (e.g., inductive loads such as a transformer or a motor), other electrical components (e.g., capacitor banks), other types of electrical power generation systems (e.g., wind power generation systems and/or other renewable power generation systems), and other suitable mechanical and/or electrical components.

As shown in FIG. 1, the grid 160 can include electrical power input lines 102, a substation 104, electrical power transmission lines 108, and a distribution station 110 electrically connected to one another. The electrical power input lines 102 can carry single or three phase alternating current (AC) generated by one or more electrical power generators (not shown) to the substation 104. The substation 104 can then step down the voltage of the AC (e.g., from 345 kilo Volts (kV) to 69 kV or from any particular voltage to a lower voltage) before transmitting the AC over the electrical power transmission lines 108 to the distribution substation 110. The distribution substation 110 further steps down the voltage of the AC (e.g., to 13.8 kV or to any other voltage) prior to transmitting the AC to the first customer premises 120 via electrical transmission lines 112a and to a distribution device 114 via electrical transmission lines 112b and then to the second customer premises 140.

In the illustrated embodiment, the first customer premises 120 include an industrial load 124, first arrays 130a of photovoltaic cells, and a first inverter 126a electrically coupled to one another. The first arrays 130a can produce a direct current (DC) from solar irradiance and provide the DC to the first inverter 126a. The first inverter 126a converts the DC into AC usable by the industrial load 124 and/or the grid 160. The first customer premises 120 can also include a first switch 122 at the border between the grid 160 and the first customer premises 120. In other embodiments, the first customer premises 120 can include other suitable electrical components in addition to or in lieu of those shown in FIG. 1.

As shown in FIG. 1, the second customer premises 140 include a residential load 144, second arrays 130b of photovoltaic cells, and a second inverter 126b. The second arrays 130b produce a DC and provide the DC to the second inverter 126b, which converts the DC into AC usable by the residential load 144 and/or the grid 160. The second customer premises 140 can also include a second switch 142 at the border between the grid 160 and the second customer premises 140. In other embodiments, the second customer premises 140 can include other suitable electrical components in addition to or in lieu of those shown in FIG. 1.

As described in more detail below, the first and/or second inverters 126a and 126b (hereinafter referred to as “the inverter 126”) can include a controller (not shown in FIG. 1) that is configured to (1) sample a voltage signal of the grid 160; (2) extract a fundamental frequency component from the sampled voltage signal; and (3) control power output from the first and/or second arrays 130a and 130b (hereinafter referred to as “the arrays 130”) to the grid 160. It is believed that by implementing such controls, a more reliable and stable line reference of the grid 160 can be obtained. Thus, the risk of degrading control stability of the grid 160, causing echoing of THD in the grid 160, and/or other problems for the grid 160 may be reduced.

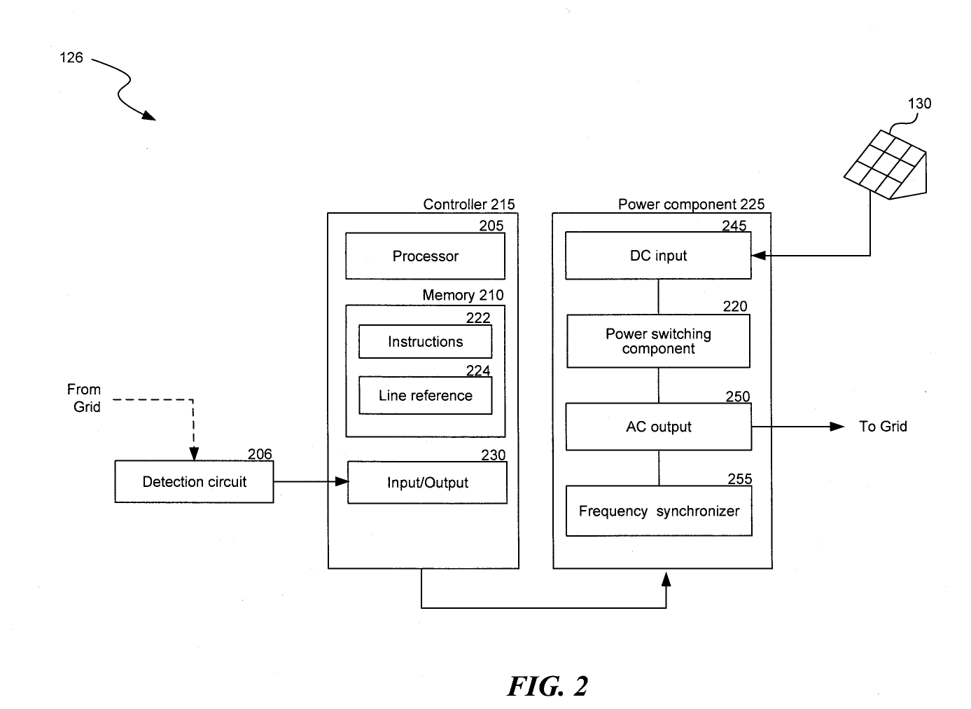

FIG. 2 is a schematic block diagram illustrating certain components of the inverter 126 configured in accordance with embodiments of the technology. As shown in FIG. 2, the inverter 126 can include a detection circuit 206, a controller 215, and a power component 225 operatively coupled to one another. Even though the foregoing components are shown as integrated in the inverter 126, in other embodiments, these components may be separate from but operatively coupled to the inverter 126. In further embodiments, the inverter 126 may also include circuit boards, capacitors, transformers, inductors, electrical connectors, and/or other components that perform and/or enable performance of various functions associated with the conversion of DC into AC and/or other functions described herein.

In the illustrated embodiment, the power component 225 includes a DC input component 245, a power switching component 220, an AC output component 250, and a frequency synchronizer 255. The DC input component 245 can be configured to receive a DC produced by the arrays 130 and provide the received DC to the power switching component 220. The power switching component 220 can include insulating gate bipolar transistors (IGBTs), electromechanical switches, and/or other suitable components that can transform DC into AC for output by the AC output component 250 to the grid 160 (FIG. 1).

The frequency synchronizer 255 can be configured to synchronize frequency of the AC produced by the power switching component 220 to that of the grid 160. In one embodiment, the frequency synchronizer 255 can include a phase-locked loop (“PLL”) configured to synchronize the AC output to a voltage of the grid 160. In other embodiments, the frequency synchronizer 255 can also include oscillators, switches, and/or other suitable components.

The detection circuit 206 can include a phase detector, a frequency mixer, a phase-frequency detector, optical phase detectors, and/or other suitable detectors for measuring a voltage and/or other characteristics of the grid 160 (FIG. 1). In one embodiment, the detection circuit 206 can measure or sample the voltage on the grid 160 at a high sampling frequency (e.g., about 40 kHz to about 160 kHz) within a small time window (e.g., 80 ms). The sampled voltage signals may then be averaged, filtered, and/or otherwise manipulated to generate a grid voltage signal. In other embodiments, the detection circuit 206 can sample the voltage of the grid 160 at other sampling frequencies. The detection circuit 206 can then supply the acquired grid voltage signal to the controller 215.

The controller 215 can include a processor 205 operatively coupled to a memory 210 and input/output component 230. The processor 205 can include a microprocessor, a field-programmable gate array, and/or other suitable logic devices. The memory 210 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the processor 205. The input/output component 230 can include a display, a touch screen, a keyboard, a mouse, a data port, and/or other suitable types of input/output components configured to accept input from the detection circuit 206 and provide output to an operator and/or the power component 225.

In certain embodiments, the controller 215 can include a personal computer operatively coupled to the other components of the inverter 126 via a communication link (e.g., a USB link, an Ethernet link, a Bluetooth link, etc.) In other embodiments, the controller 215 can include a network server operatively coupled to the other components of the inverter 126 via a network connection (e.g., an internet connection, an intranet connection, etc.) In further embodiments, the controller 215 can include a process logic controller, a distributed control system, and/or other suitable computing frameworks.

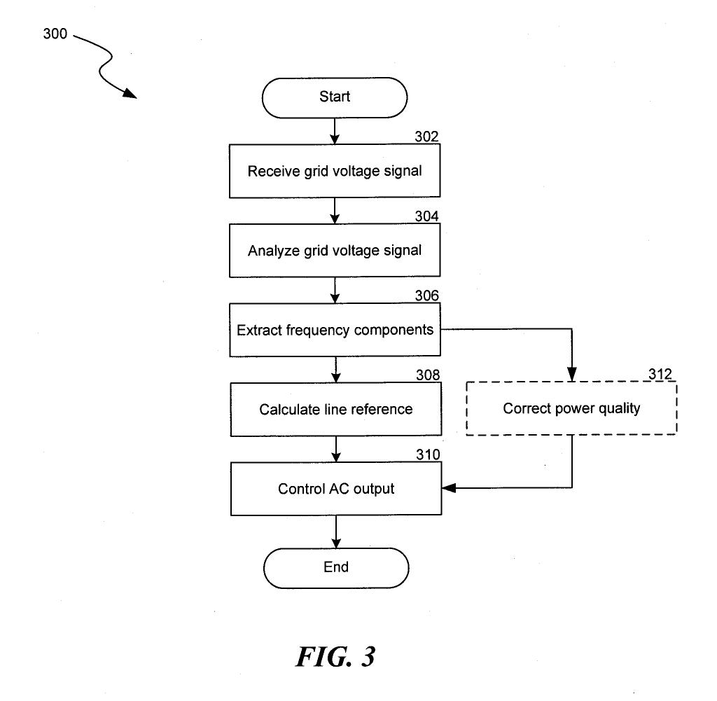

The memory 210 can store instructions 222 and a line reference 224. The line reference 224 can include a measured and/or derived voltage, phase, frequency, and/or other types of model for the grid 160. For example, in one embodiment, the line reference 224 can include a sinusoidal waveform with an amplitude, a phase angle, and a frequency representing a voltage of the grid 160 in time domain. In another example, the line reference 224 can include an expression in complex numbers representing a voltage of the grid 160 in frequency domain. In other embodiments, the line reference 224 can include other suitable representations of a voltage of the grid 160. Based on the line reference 224, the controller 215 can control the operation of the power component 225 such that the AC output from the power component 225 can be accurately synchronized with the grid 160. Details of deriving the line reference 224 are described in more detail below with reference to FIG. 3.

The instructions 222 can include computer programs, procedures, modules, and/or processes written as source code in a conventional programming language, such as the C++ programming language, and may be presented for execution by the processor 205 of the controller 215. For example, in one embodiment, the instructions 222 can include a proportional-integral-derivative module, a proportional-integral module, and/or other suitable control modules configured to control a phase, a frequency, and/or other characteristics of the AC output to the grid 160 based on the line reference 224. In another embodiment, the instructions 222 can include modules configured to perform at least one of a fast Fourier transformation, a discrete Fourier transformation, a fractional Fourier transformation, and a Laplace transformation on the grid voltage signal to generate and/or update the line reference 224, as discussed in more detail below with reference to FIG. 3.

FIG. 3 is a flow diagram of a process 300 for deriving a high-accuracy line reference signal of a grid in accordance with an embodiment of the technology. Various embodiments of the process 300 may be implemented as computer programs, modules, routines in a conventional programming language and stored as part of the instructions 222 in the memory 210 (FIG. 2).

An initial stage of the process 300 (block 302) includes receiving data of the grid voltage signal from the detection circuit 206 (FIG. 2). In one embodiment, the received data may be in a digital form. In other embodiments, the received data may be in analog form, and the process 300 can further include digitizing the received data of the grid voltage. In further embodiments, the received data of the grid voltage may be filtered. For example, in certain embodiments, data outside a predetermined time window may be removed. In other embodiments, the received data may also be compressed and/or otherwise manipulated before proceeding to the next stage of the process 300.

Another stage of the process 300 includes analyzing the received data of the grid voltage to derive various frequency components of the voltage signal (block 304). For example, in certain embodiments, a fast Fourier transformation, a discrete Fourier transformation, a fractional Fourier transformation, a Laplace transformation, and/or other suitable transformation may be applied to the received data of the grid voltage. As a result, a new set of data is created, representing amplitude, phase angle, and frequency of various frequency components of the grid voltage signal. In other embodiments, the received sampling data may be decomposed in frequency domain using other suitable techniques.

Another stage of the process 300 includes extracting a fundamental frequency component from the new set of data representing various frequency components of the grid voltage signal (block 306). In one embodiment, a fundamental frequency component may be extracted by evaluating voltage amplitude values at various frequencies and selecting a frequency component with the largest amplitude value. In other embodiments, the fundamental frequency component may be extracted by selecting a frequency component closest to a predetermined “ideal” frequency (e.g., 60 Hz). In further embodiments, extracting the fundamental frequency component may include a combination of the foregoing techniques and/or other suitable techniques. In at least some of the foregoing embodiments, non-fundamental frequency components may also be extracted along with the fundamental frequency component.

Subsequently, another stage of the process 300 includes calculating a line reference 224 (FIG. 2) based on the extracted fundamental frequency component (block 308). In one embodiment, calculating the line reference 224 can include constructing a sinusoidal waveform based on the amplitude, phase angle, and frequency of the extracted fundamental frequency component via reverse fast Fourier transformation. In other embodiments, calculating the line reference 224 can include constructing a cosine and/or other suitable waveforms based on the extracted fundamental frequency component. In further embodiments, calculating the line reference 224 can also include determining an expression of complex numbers and/or other suitable expressions in frequency domain that represent the grid voltage signal. The calculated line reference can then be stored in the memory 210 of the controller 215 (FIG. 2).

Another stage of the process 300 can then include controlling the AC output from the power component 225 (FIG. 2) based on the calculated line reference 224. For example, in one embodiment, the phase and/or zero crossing of the AC output from the power component 225 can be synchronized (e.g., using a PLL), not with the measured grid voltage signal, but instead with the calculated line reference 224. In other embodiments, controlling the AC output can include synchronizing a frequency error, a total vector error, a root-mean-square voltage error, and/or other characteristics of the AC output based on the line reference 224.

Optionally, in certain embodiments, the process 300 can include correcting power quality of the grid 160 based on the analyzed grid voltage signal (block 312). For example, in one embodiment, compensation waveforms may be calculated based on the non-fundamental frequency components to cancel, reduce, or otherwise compensate for THD in the grid 160 on a ½ cycle or other suitable cycle basis. In other embodiments, other waveforms may be calculated based on the non-fundamental frequency components to compensate for other types of distortions in the grid 160. The power component 225 can then inject currents into the grid 160 based on the calculated compensation waveforms.

Several embodiments of the process 300 can improve the reliability and stability of the line reference 224 when compared to conventional techniques (block 310). Without being bound by theory, it is believed that measured grid voltage signal(s) typically include a large number of frequency components as a result of various types of distortions (e.g., non-linear loads on the grid 160). As a result, the measured grid voltage signal can be distorted enough to be unstable and unreliable as the indicator of the current or “ideal” operating state of the grid 160. Thus, by decomposing the measured grid voltage signal in frequency domain, extracting the fundamental frequency component, and constructing the line reference 224 based solely on the extracted fundamental frequency component, the negative impact of various distortions on the grid 160 may be at least reduced or eliminated.

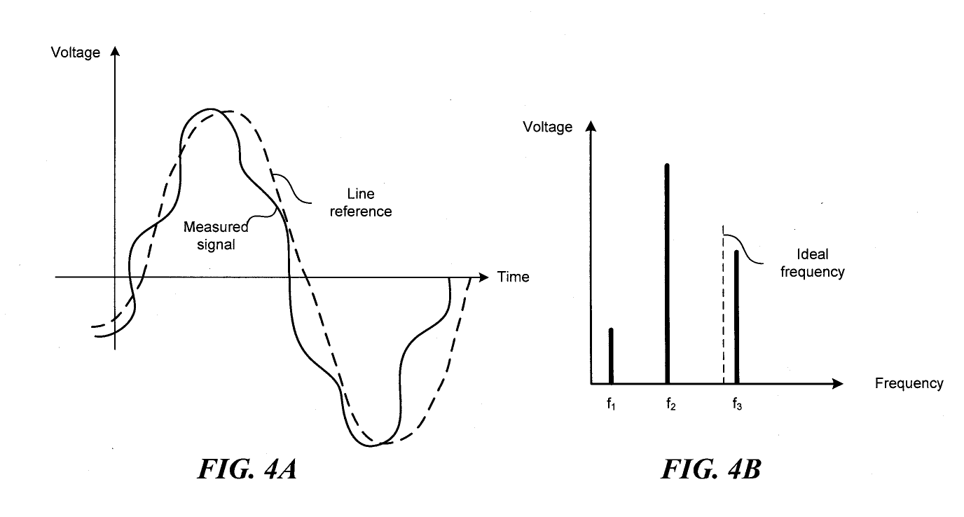

FIG. 4A is a voltage versus time plot of an example of a measured grid voltage signal and a corresponding derived line reference in accordance with an embodiment of the technology. FIG. 4B is a voltage versus frequency plot of the example measured grid voltage signal of FIG. 4A in frequency domain. As shown in FIG. 4A, the measured grid voltage signal can have an irregular waveform as a result of various distortions. In comparison, the derived line reference can be generally “clean” with a waveform at least generally similar to that of a sinusoidal waveform. As shown in FIG. 4B, in the illustrated example, the decomposed grid voltage signal has first, second, and third frequency components at frequencies f₁ to f₃, respectively. The second frequency component at f₂ has the largest amplitude and, thus in certain embodiments, may be selected as the fundamental frequency component. In another embodiment, the third frequency component at f₃ may be selected as the fundamental frequency component because it is the closest to an “ideal” or expected operating frequency of the grid 160 (FIG. 1). In further embodiments, the fundamental frequency component may be selected based on other suitable criteria.

From the foregoing, it will be appreciated that specific embodiments of the invention have been described herein for purposes of illustration, but that various modifications may be made without deviating from the spirit and scope of the invention. For example, the elements of one embodiment can be combined with other embodiments in addition to or in lieu of the elements of other embodiments. Accordingly, the disclosure is not limited except as by the appended claims.

We claim:

1. A method for controlling an inverter coupled to a grid, comprising:
receiving data representing a voltage signal of the grid;
analyzing the received data in frequency domain;
extracting a fundamental frequency component from the analyzed data in frequency domain;
calculating a waveform based on the fundamental frequency component; and
controlling an output of the inverter based on the calculated waveform.

2. The method of claim 1 wherein:
analyzing the received data includes applying at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component;
extracting the fundamental frequency component includes selecting the fundamental frequency component from the plurality of frequency components;
calculating the waveform includes calculating a sine or cosine waveform based on the extracted fundamental frequency component, the calculated waveform being substantially independent of the non-fundamental frequency component; and
controlling the output of the inverter includes synchronizing at least one of a phase and frequency of the output of the inverter with the calculated waveform.

3. The method of claim 1 wherein:
analyzing the received data includes applying at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component;
extracting the fundamental frequency component includes selecting the fundamental frequency component from the plurality of frequency components;
calculating the waveform includes calculating a first waveform based on the extracted fundamental frequency component and a second waveform based on the non-fundamental frequency component, the calculated second waveform being configured to compensate for the non-fundamental frequency component; and
controlling the output of the inverter includes synchronizing at least one of a phase and frequency of the output of the inverter with the calculated first waveform and injecting a current into the grid based on the calculated second waveform.

4. The method of claim 1 wherein analyzing the received data includes applying at least one of a fast Fourier transformation, a discrete Fourier transformation, a fractional Fourier transformation, and a Laplace transformation to the received data.

5. The method of claim 1 wherein:
analyzing the received data includes applying at least one of a fast Fourier transformation, a discrete Fourier transformation, a fractional Fourier transformation, and a Laplace transformation to the received data to derive a plurality of frequency components; and
the plurality of frequency components include the fundamental frequency component and a non-fundamental frequency component.

6. The method of claim 1 wherein:
analyzing the received data includes applying at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component; and
extracting the fundamental frequency component includes selecting the fundamental frequency component from the plurality of frequency components.

7. The method of claim 1 wherein:
analyzing the received data includes applying at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component;
calculating the waveform includes calculating a waveform based on the non-fundamental frequency component, the calculated waveform being configured to compensate for the non-fundamental frequency component; and
controlling the output of the inverter includes injecting a current into the grid based on the calculated second waveform.

8. A power inverter, comprising:
a direct current (DC) input component configured to receive a DC produced by one or more photovoltaic cells;
a power switching component configured to generate alternating current (AC) from the received DC;
an AC output component configured to output the generated AC to a grid;
a detection circuit configured to sample data representing a voltage of the grid;
a controller operably coupled to the power switching component and the detection circuit, the controller including a computer storage medium containing instructions executable to perform a process comprising:
receiving the sampled data from the detection circuit;
analyzing the received data in frequency domain;
extracting a fundamental frequency component from the analyzed data in frequency domain;
calculating a waveform based solely on the fundamental frequency component; and
controlling an output of the inverter based on the calculated waveform.

9. The power converter of claim 8 wherein analyzing the received data includes applying at least one of a fast Fourier transformation, a discrete Fourier transformation, a fractional Fourier transformation, and a Laplace transformation to the received data.

10. The power converter of claim 8 wherein:
analyzing the received data includes applying at least one of a fast Fourier transformation, a discrete Fourier transformation, a fractional Fourier transformation, and a Laplace transformation to the received data to derive a plurality of frequency components; and
the plurality of frequency components include the fundamental frequency component and a non-fundamental frequency component.

11. The power converter of claim 8 wherein:
analyzing the received data includes applying at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component; and
extracting the fundamental frequency component includes selecting the fundamental frequency component from the plurality of frequency components.

12. The power converter of claim 8 wherein:
analyzing the received data includes applying at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component;
calculating the waveform includes calculating a waveform based on the non-fundamental frequency component, the calculated waveform being configured to compensate for the non-fundamental frequency component; and
controlling the output of the inverter includes injecting a current into the grid based on the calculated second waveform.

13. A controller for controlling an inverter coupled to a grid, comprising:
a processor configured to receive data representing a voltage signal of the grid, analyze the received data in frequency domain, extract a fundamental frequency component from the analyzed data in frequency domain, and calculate a waveform based solely on the fundamental frequency component; and
a memory storing the calculated waveform and instructions configured to control an output of the inverter based on the calculated waveform.

14. The controller of claim 13 wherein the processor is configured to apply at least one of a fast Fourier transformation, a discrete Fourier transformation, a fractional Fourier transformation, and a Laplace transformation to the received data.

15. The controller of claim 13 wherein:
the processor is configured to apply at least one of a fast Fourier transformation, a discrete Fourier transformation, a fractional Fourier transformation, and a Laplace transformation to the received data to derive a plurality of frequency components; and
the plurality of frequency components include the fundamental frequency component and a non-fundamental frequency component.

16. The controller of claim 13 wherein:
the processor is configured to apply at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component; and
the processor is configured to extract the fundamental frequency component from the plurality of frequency components.

17. The controller of claim 13 wherein:
the processor is configured to apply at least one of a fast Fourier transformation, a discrete Fourier transformation, a fractional Fourier transformation, and a Laplace transformation to the received data to derive a plurality of frequency components;
the plurality of frequency components include the fundamental frequency component and a non-fundamental frequency component;
the processor is also configured to calculate a waveform based on the non-fundamental frequency component, the calculated waveform being configured to compensate for the non-fundamental frequency component; and
the memory stores instructions configured to inject a current into the grid based on the calculated waveform.
